(19) United States
(12) Patent Application Publication
(10) Pub. No.: US 2009/0226673 A1
(43) Pub. Date: Sep. 10, 2009

(54) HIGH FRICTION COATING FORMULATIONS AND SYSTEMS AND COATED ARTICLES THEREOF EXHIBITING RADAR SIGNATURE REDUCTION AND METHODS OF PROVIDING THE SAME

(76) Inventors: Fritz J. FRIEDERSDORF, Earlysville, VA (US); Christy R. Vestal, Charlottesville, VA (US); James T. Garrett, Gordonsville, VA (US)

Correspondence Address: NIXON & VANDERHYE, PC, 901 NORTH GLEBE ROAD, 11TH FLOOR, ARLINGTON, VA, 22203, US

(21) Appl. No.: 12/121,191

(22) Filed: May 15, 2008

Related U.S. Application Data
(60) Provisional application No. 60/924,465, filed on May 16, 2007.

(51) Int. Cl. B32B 3/30; B32B 9/04; B32B 5/16; B05D 3/02; B05D 5/00; G21F 1/10

(52) U.S. Cl. 428/167; 428/446; 428/323; 427/372.2; 427/256; 523/137

(57) ABSTRACT

High friction and radar attenuating coating formulations are provided and include a resin matrix, a particulate friction additive dispersed in the resin matrix in an amount sufficient to achieve a minimum coefficient of friction according to MIL-PRF-24667B(SH), and a particulate dielectric filler dispersed in the resin matrix in an amount sufficient to achieve a permitivitty (∈′) of less than about 10 and a loss tangent (tan δ) of less than about 0.05. A substrate surface may be coated with the coating formulation so as to provide a topcoat layer thereon. The topcoat layer may thus be applied directly onto the substrate surface. Alternatively, the coating formulation is present as a topcoat layer component of a coating system on the substrate which further comprises an intermediate layer interposed between the topcoat layer and a surface of the substrate and/or a primer layer coated directly onto the surface of a substrate between the topcoat layer and the substrate. In some embodiments, the coating formulation is applied so as to form a series of substantially parallel ridges having a predetermined directional orientation. In certain preferred embodiments, the coating formulation is applied to a block area on the substrate surface comprised of plural areal regions, wherein the directional orientation of the substantially parallel ridges of one areal region are angularly biased with respect to the directional orientation of the substantially parallel ridges of an adjacent areal region.

### CROSS-REFERENCE TO RELATED APPLICATION

This application is based on and claims domestic priority benefits under 35 USC § 119(e) from U.S. Provisional Application Ser. No. 60/924,465 filed on May 16, 2007, the entire content of which is expressly incorporated hereinto by reference.

### GOVERNMENT RIGHTS STATEMENT

This invention was made with Government support under Contract No. N65538-06-M-0106 awarded by the US Navy. The Government has certain rights to the invention.

### FIELD OF THE INVENTION

The present invention relates generally to coating formulations, systems and techniques which reduce the radar signature of an article. In especially preferred forms, the present invention relates to coating systems and methods which reduce an article's radar signature when coated thereon.

### BACKGROUND AND SUMMARY OF THE INVENTION

Radar absorbing coatings and materials are widely used in military applications for improving stealth characteristics of a range of military vehicles and aircraft. Besides radar absorbing properties, coatings often are required to have other functional properties. The combination of properties required for military ships includes high friction to improve the safety of topside ship deck operations, and corrosion and environmental resistance to protect ship structures and reduce maintenance burdens. The present invention has an advantageous combination of radar absorbing, substrate protection and high friction properties.

Radar absorbing materials and coatings are widely used in aerospace applications such as aircraft, unmanned aerial vehicles, and missiles. Naval applications include the use of composites and coatings for reducing the radar signature of ships. In preferred forms, the coating systems and methods of the present invention are useful for radar signature reduction of ship decks and is also functional as a durable high friction surface. The coating systems of the present invention may also include corrosion inhibitors to protect the ship structure from corrosion.

In general, radar absorbing structures and materials are composites of dielectric and magnetic materials that are used to absorb specular and non-specular reflections. (Knott et al, Radar Cross Section. 2nd ed. 1993, Norwood, Mass. Artech House, Inc. 611^{|1|}) Scattering into non-specular directions is caused by surface traveling waves, edge waves, creeping waves, and diffraction from edges and discontinuities like gaps and cracks in the material. Radar absorbing structures, composites and coatings are designed to minimize the intensity of reflected electromagnetic waves which can be accomplished by impedance matching such as with graded dielectric materials or resonant absorbers such as Salisbury screens and Jaumann absorbers. (Säily et al, Studies on Specular and Non-Specular Reflectivities of Radar Absorbing Materials (RAM) at Submillmetre Wavelengths, Report S258, 2003, Helsinki University of Technology, Department of Electrical and Communications Engineering: Helsinki, Finland. p. 62.) The conventionally known materials do not: 1) have the proper combination of specular and non-specular absorber properties, 2) protect ship structures from corrosion, and 3) have high friction surfaces. Furthermore, these known materials are not compatible with traditional coating application processes used in ship construction and maintenance, and are not resistant to environmental weathering. Thus, further improvement is needed in this art. ¹The entirety of this publication as well as all other patent and non-patent publications cited below are expressly incorporated hereinto by reference.

Resonant absorbers operate by producing ¼ wavelength phase shifted reflections from the front face (air/coating interface) and back face (metal substrate) that destructively interfere. These type absorbers include narrow bandwidth Salisbury screens, and broader band, but thicker, Jaumann absorbers. The narrow band properties of Salisbury screens are not acceptable for stealth applications that require broad band absorbance. Broader band response of Jaumann absorbers is achieved using thicker multilayer structures. These absorbers are very thick having conductive interlayers separated by dielectric layers. Jaumann absorbers cannot be produced through tradition coating operations such as those used to coat the surfaces and decks of ships.

U.S. Pat. No. 4,606,848 teaches the use of a conductive fiber or particles in paint for microwave radar absorbing properties. The disclosure does not mention the use of magnetic materials for reducing non-specular reflections, a corrosion inhibitor containing primer for substrate protection, or the use of a low loss, high roughness and durable surface coating for low reflectance, improved traction and enhanced service life.

U.S. Pat. Nos. 5,537,116 and 6,518,911 teach the use of a resonant absorber composite or panel structures to control radar reflections, respectively. These composite panel structures do not make use of magnetic materials for reducing non-specular reflections due to surface waves, corrosion inhibitor containing primer for substrate protection, or the use of a low loss, high roughness and durable surface coating for low reflectance, improved traction and enhanced service life. These patents also do not teach the means to adapt the disclosed composite structure to convention coating application processes such as spray and roll.

U.S. Pat. No. 5,552,455 teaches the use of magnetic particles in a binder to form a coating with broad band radar absorbing properties. U.S. Pat. No. 5,892,476 teaches an electromagnetic absorptive composition based on coated microparticles. These patents do not teach the use of corrosion inhibitor containing primer for substrate protection, or the use of a low loss, high roughness and durable surface coating for low reflectance, improved traction and enhanced service life.

U.S. Pat. No. 6,518,911 teaches a multilayer resonant absorber that has non-skid properties for use on ship decks. This patent does not teach the formulation and use of a roll applied, low loss, high roughness and durable surface coating for low reflectance, improved traction and enhanced service life. The use of a resonant absorber requires an intermediate layer having high tolerance control on thickness. The use of a graded dielectric coating is not disclosed. A means for controlling surface waves and non-specular reflections is not described, nor the use of corrosion inhibitors for protection of the substrate.

Generally, the radar absorbing non-skid coating system of the present invention combines graded dielectric properties with a high friction surface to enhance the radar absorbing properties of metal substrates or structures. The radar absorbing characteristics of the non-skid coating system are controlled, through materials selection, to minimize the front face reflection that contributes to low angle backscatter, and to maximize absorption within the coating. The topcoat of the radar absorbing non-skid system is designed to be radar transparent (low loss) while forming a high friction surface. The primer and any necessary intermediate layers of the coating system are designed to have more lossy (energy-dissipative) radar absorbing electromagnetic properties that attenuate surface waves and provide non-toxic corrosion inhibition.

In preferred embodiments, the radar absorbing non-skid coating systems of the present invention include a low loss topcoat that minimizes radar reflections from the surface or front face. The topcoat may optionally be provided as part of a coating system which includes one or more graded dielectric intermediate coating layers and a primer containing corrosion inhibitors and magnetic materials. In certain aspects, the topcoat is formulated to be a deck coating that is highly textured for traction and safety. Furthermore, the topcoat may be formulated to be environmentally resistant to exterior environmental weathering and chemicals that are associated with activities that occur on a ship's deck. The layers can be rolled, sprayed or cast to form a uniform coating layer that has loss properties tailored to minimize radar reflection and maximize absorption.

In especially preferred embodiments, high friction radar attenuating coating formulations are provided which are comprised of a resin matrix, a particulate friction additive dispersed in the resin matrix in an amount sufficient to achieve a minimum coefficient of friction according to MIL-PRF-24667B(SH), and a particulate dielectric filler dispersed in the resin matrix in an amount sufficient to achieve a permitivitty (∈′) of less than about 10 and a loss tangent (tan δ) of less than about 0.05°.

The dielectric filler is advantageously at least one selected from the group consisting of calcium magnesium silicate, magnesium silicate hydroxide, magnesium aluminum silicate, potassium aluminum silicate, alkali alumino silicate, wollastonite, talc and muscovite. In certain embodiments it is preferred that the dielectric filler be present in an amount to achieve a permitivitty of between about 1.5 to about 10, for example, in an amount of between about 14 to about 45 wt. %, based on the total weight of the coating formulation. The dielectric filler will advantageously have an average particle size of between about 0.1 to about 200 μm.

The friction additive may be at least one selected from the group consisting of aluminum ceramics and polymeric particulates, for example, at least one selected from the group consisting of aluminum oxide, alumina-zirconia oxide, alumina-spinel materials, polyethylene grit and polypropylene grit. The friction additive is preferably present in an amount between about 30 to about 70 wt. %, based on the total weight of the coating formulation so as to achieve a coefficient of friction both before and after wear that meets the standards according to MIL-PRF-24667B(SH). In certain embodiments, the friction additive has an average particle size of between about 30 grit to about 80 grit.

A substrate surface may be coated with the coating formulation so as to provide a topcoat layer thereon. The topcoat layer may thus be applied directly onto the substrate surface. Alternatively, the coating formulation is present as a topcoat layer component of a coating system on the substrate which further comprises an intermediate layer interposed between the topcoat layer and a surface of the substrate and/or a primer layer coated directly onto the surface of a substrate between the topcoat layer and the substrate. If present, the intermediate layer may comprise an electrically conductive filler dispersed in a resin matrix that may be the same as or different from the resin matrix of the topcoat layer. The optional primer layer may comprise a particulate magnetic filler dispersed in a resin matrix which may be the same as or different from the resin matrix of the coating formulation forming the topcoat layer.

Anti-slip and radar attenuating properties may thus be imparted to a substrate by applying onto a substrate surface a coating layer comprised of a flowable coating formulation as described previously, and thereafter allowing the coating formulation to harden on the substrate surface. Preferably, the coating formulation is applied so as to form a series of substantially parallel ridges having a predetermined directional orientation. In certain preferred embodiments, the coating formulation is applied to a block area on the substrate surface comprised of plural areal regions, wherein the directional orientation of the substantially parallel ridges of one areal region are angularly biased (e.g., greater than 0° to less than 180°, preferably between about 30° to about 90°) with respect to the directional orientation of the substantially parallel ridges of an adjacent areal region.

These and other aspects and advantages will become more apparent after careful consideration is given to the following detailed description of the preferred exemplary embodiments thereof.

### BRIEF DESCRIPTION OF THE ACCOMPANYING DRAWINGS

Reference will hereinafter be made to the accompanying drawings, wherein like reference numerals throughout the various FIGURES denote like structural elements, and wherein,

FIG. 1 is a schematic cross-sectional depiction of a high friction coating system according to an embodiment of the present invention having radar absorption characteristics;

FIG. 2 is a plan view photograph of the top coat layer showing the parallel ridged texturing thereof,

FIG. 3 is a schematic plan view of a roll-applied coated surface wherein the parallel ridges of the textured top coat are oriented at angles relative to the ridges of adjacent coated surface sections;

FIG. 4 is a graph of the permittivity loss tangents (tan δ) versus frequency (GHz) of a commercial nonskid topcoat formulation and a non-skid topcoat formulation in accordance with Topcoat Formula T-1 of EXAMPLE 1 below;

FIG. 5 is a graph of the permittivity loss tangents (tan 6) versus frequency (GHz) of Intermediate Formulas I-1 and I-2 as described in EXAMPLES 4 and 5, respectively, below; and

FIGS. 6 and 7 are photographs of the impact resistance testing in accordance with EXAMPLE 11 below.

### DETAILED DESCRIPTION OF THE INVENTION

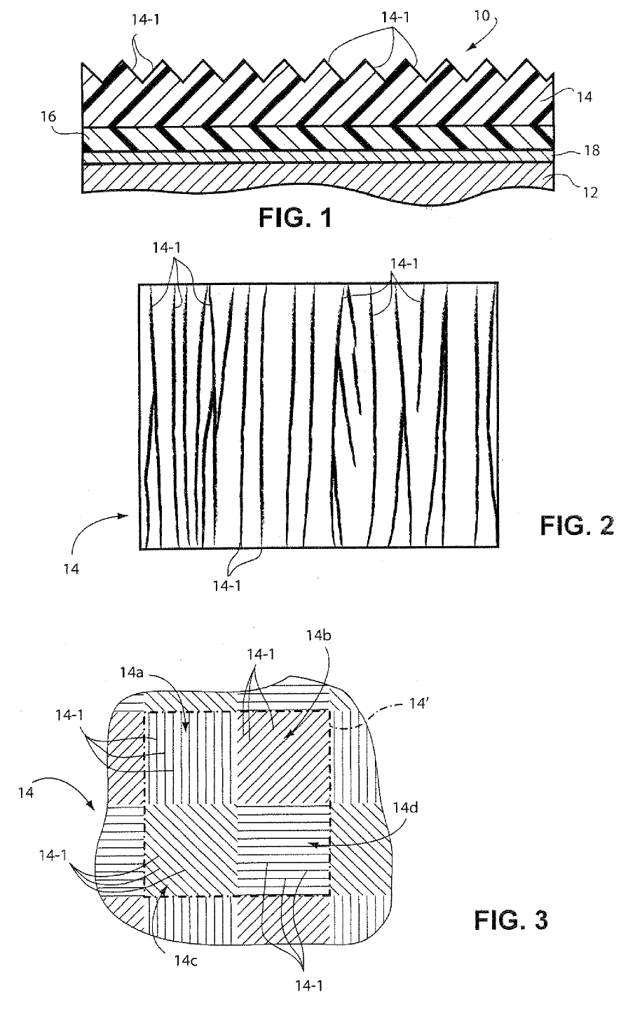

One example of a coating system 10 in accordance with the present invention is depicted graphically in accompanying FIG. 1 as being coated upon a surface of a substrate 12. The coating system 10 may be applied onto virtually any suitable rigid substrate 12. Most preferably, the substrate 12 is formed of a metal or metal alloy, for example, steel, aluminum, iron or the like, that typically form the exterior structural components of ships aircraft, motorized land vehicles and the like.

As shown, the coating system will include a top coat layer 14 which in certain preferred embodiments exhibits a series of substantially parallel ridges (a representative few of which are depicted in FIGS. 1-3 by reference numeral 14-1) forming substantially unidirectional peaks and valleys. The top coat layer 14 may be applied directly onto the surface of the substrate 12 as depicted in FIG. 1 or alternatively may be applied onto an intermediate layer 16 which itself is applied onto a primer layer 18. The top coat layer 14 provides for non-skid and low loss dielectric properties as it is exposed to radiation and physical wear. The optional intermediate layer 16 may serve to enhance dielectric loss properties of the top coat layer. The optional primer layer 18 may be employed to further enhance radar attenuation of the system 10. The intermediate and primer layers 16 and 18, respectively, may be employed together as depicted in FIG. 1 or may be employed separately with the covering topcoat layer 14. The topcoat layer may thus be applied directly onto the surface of the substrate 12 or may be employed with one or both of the optional intermediate and primer layers 16, 18; respectively. Each of these respective layers are further described below.

### I. Top Coat Layer

Preferred embodiments of the present invention will necessarily include a top coat layer 14 formed of a coating composition which exhibits satisfactory anti-slip and low loss dielectric properties comprised of a particulate friction additive and a particulate dielectric filler dispersed in a curable resin matrix material.

Any suitable particulate friction additive may be employed in the practice of the present invention. Preferred are particulate ceramic and/or plastics materials having average particles sizes of between about 30 to about 80 grit. Especially preferred embodiments will employ a particulate friction additive of about 60 grit. The amount of the friction additive is sufficient to achieve satisfactory abrasion resistance. Usually the particulate friction additive will be present in the coating compositions of the present invention in an amount between about 30 to about 70 wt. %, preferably between about 40 to about 60 wt. %, based on the total composition weight. The particulate friction additive will advantageously be present in an amount to meet the minimum dry, wet and oily coefficients of friction (COF) before wear according to MIL-PRF-24667B(SH) (3 Jun. 2005) (incorporated fully hereinto by reference) of 0.95, 0.90 and 0.80, respectively. Most preferably, the friction additive will be present so as to achieve a COF under both dry and wet conditions according to MIL-PRF-24667B(SH) of at least 1.00.

Preferred exemplary particulate friction additives include aluminum based ceramics, such as aluminum oxide (e.g. Alodur® products from Treibacher Schleifmittel Corporation and Cerpass-XTL® from Saint-Gobain), alumina-zirconia oxide (e.g. ZF® Alundum and ZS® Alundum from Saint-Gobain), alumina-spinel materials (e.g. 3M™ Cubitron™ Grain 321 from 3M), alumina-garnet materials (e.g. 3M™ Cubitron™ Grain 324 from 3M), polymeric particulates, such as polyethylene grit (e.g. General Polymers® Non-skid Additive 5190 and 5191 from Sherwin Williams), polypropylene grit (e.g. Griptex Non-skid additive from AwlGrip), and the like, may also be satisfactorily employed.

The dielectric fillers will be present in the coating compositions in an amount sufficient to achieve a permitivitty (∈′) of less than about 10, for example between about 1.5 to about 10, preferably between about 1.4 to about 4.6, and a loss tangent (tan δ) of less than about 0.05. Typically, the dielectric fillers will be present in an amount between about 14 to about 45 wt. %, preferably between about 25 to about 35 wt. %, based on the total composition weight. The average particle size of the dielectric fillers is preferably between about 0.1 to about 200 μm, preferably between about 1 to about 15 μm.

Preferred dielectric fillers include hydrous calcium magnesium silicate, magnesium silicate hydroxide, magnesium aluminum silicate, potassium aluminum silicate, alkali alumino silicate, wollastonite, talc, muscovite, and mica. The dielectric fillers should be of sufficiently high purity so as to not affect disadvantageously the dielectric properties when blended with the compositions of the present invention. Thus, impurities in the preferred dielectric filler materials should be present in an amount of less than 2 vol. %, and more preferably less than about 0.5 vol. % based on the total volume of the dielectric filler.

Especially preferred particulate dielectric fillers include Zeeospheres™ G200 from 3M™ with particle size range 1-12 μm and ∈′ of 3.7-4.6, Zeeospheres™ W610 from 3M™ with particle size of 40 μm and ∈′ of 3.19, Nicron® 403 from Luzenac with average particle size of 4.8 μm and approximate ∈′ of 5.3, Vancote® W50ES from R.T. Vanderbilt with average particle size of 2.8 μm and ∈′ of 6.2, Nytal® 7700 from R.T. Vanderbilt with average particle size of 2.7 μm and approximate ∈′ of 5.3, Nytal®D 3300 from R.T. Vanderbilt with average particle size of 10.5 μm and approximate ∈′ of 5.3, and Mistron® 403 from Luzenac with average particle size of 4.8 μm and approximate ∈′ of 5.3.

As noted previously, the friction additive and the dielectric particulate materials are dispersed in (blended with) a suitable curable resin matrix material. Preferred resin matrix materials include epoxy and urethane based resins, such as bisphenol-A based epoxies (e.g., Epon™ 828) cured with modified polyamide, modified aliphatic amine, amidoamine, cycloaliphatic amine, aromatic amine hardening agents, and polyurethanes. Especially preferred curing agents include Ancamide® 2353 from Air Products, Ancamide® 2432 from Air Products, Versamine® C31 from Cognis, EpiKure® 3277 from Hexion Specialty Chemicals, and EpiKure® 3072 from Hexion Specialty Chemicals.

The topcoat formulations most preferably are solvent based materials which allow for application by conventional coating techniques, for example, by roll coating, spray coating, and the like. The solvents are selected based on the particular resin matrix material that is being employed and may include n-butanol, butyl acetate (preferably t-butyl acetate), methyl ethyl ketone (MEK), propylene glycol methyl ether (e.g., DOWANOL® PM available from Dow Chemical), and combinations of the same.

The solvent will preferably not be employed in amounts greater than about 12 wt. %, based on the total coating composition weight. In this regard, if present in amounts greater than 12 wt. %, roll coated formulations may not be capable of exhibiting a textured appearance with substantially parallel ridge rows. On the other hand, the amount of solvent should not be too low so as to achieve satisfactory coating properties. Thus, preferably, the solvent will be present in an amount between about 6 to about 12 wt. %.

The top coat formulations may also include any other conventional additive in amounts to achieve the desired effect provided that the friction and dielectric properties as discussed above are not deleteriously affected by their presence. Thus, conventional additives such as flexibilizers, color pigments, thixotropic agents and other fillers to adjust viscosity, coating performance, potlife, and other performance properties well known to those skilled in the art may be employed as desired.

When spray-applied, the topcoat layer 14 will present a uniformly rough and textured appearance over the entire visible surface. The abrasion resistant media (particulate friction additive) will thus protrude prominently above the resin matrix providing for slip-resistance. Roll coating of the topcoat formulation is preferably accomplished using a napless phenolic roller and applied so as to achieve a textured appearance forming substantially parallel ridges 14-1 as shown schematically in FIG. 1. Such ridges 14-1 will thus remain in the cured layer as surface texturing that enhances slip-resistance and radar attenuation.

In preferred embodiments, the average valley to peak height of the ridges 14-1 is preferably between about 0.15 to about 0.5 cm, more preferably between about 0.15 to about 0.25 cm. The distance measured peak-to-peak between adjacent ones of the ridges 14-1 can vary between about 0.5 to about 2 cm, preferably between about 1 to about 1.5 cm.

One especially preferred application technique in order to enhance radar attenuation of the topcoat layer 14 is depicted schematically in accompanying FIG. 3. As shown, a block 14′ is formed of adjacent areal sections 14a-14d each having substantially parallel ridges 14-1 oriented in predetermined directions. Each of the area sections 14a-14d need not be square as shown but instead may be of any shape occupying predetermined width and distance dimensions of between about 0.5 foot to about 200 feet. The areal sections are most preferably square or rectangular for ease of application.

The directional orientation of the ridges 14-1 associated with each areal section 14a-14d is angularly biased relative to the directional orientation of the ridges 14-1 associated with adjacent ones of the areal sections 14a-14d. Preferred angular bias between the directional orientations of ridges 14-1 of adjacent areal sections 14a-14d may be greater than 0° to less than 180°. Thus, angular orientations of about 30°, 45°, 60°, 90°, 120°, 135°, 150° and the like may satisfactorily be employed.

The number of the areal regions 14a-14d may vary depending on the surface to which the topcoat 14 is applied. Thus, as shown in FIG. 3, four areal regions 14a-14d are depicted as an exemplary embodiment, however, any number of areal regions, e.g., between 2 to 20 or more, may be employed in the practice of this invention. The areal regions with given orientations may be repeated to cover the substrate area. Preferred however are 4 or 9 such areal regions, which may be repeated to cover the substrate area.

A particularly preferred embodiment includes four (4) areal regions 14a-14d as shown in FIG. 3 for each block 14′ with the angular orientation of the ridges 14-1 associated with each such areal region 14a-14d being biased by about 45° relative to the angular orientation of the ridges 14-1 in each adjacent areal region 14a-14d, respectively.

### II. Intermediate Layer

If present, the intermediate layer 16 may be provided so as to enhance the dielectric loss characteristics of the topcoat layer 14. The intermediate layer will thus most preferably include a particulate electrically conductive filler dispersed (blended) in a resin matrix.

Preferred conductive fillers include carbon nanofibers, carbon nanotubes, carbon fibers (both of indefinite length and chopped staple length), graphite flakes, aluminum powders, as well as metallic flakes and particles (e.g., flakes and particles of nickel, silver, gold and the like). In addition, the conductive fillers may be coated with a metal, e.g., nickel, silver, gold, and the like, so as to enhance the electrical conductivity. Thus, nickel coated carbon fibers, nickel coated graphite flakes, nickel coated aluminum powders, silver coated graphite flakes, silver coated aluminum powders, gold coated graphite flakes and the like may be satisfactorily employed.

The conductive filler is preferably present in an amount sufficient to achieve a conductivity of a cured coating layer formed of the intermediate coating formulation of between about 25 to about 2000 μΩ-cm. Typically, the conductive filler will be present in an amount between about 0.1 to about 70 wt. % based on the total weight of the intermediate layer material. Preferred embodiments of the intermediate layer will have low aspect ratio fillers (e.g., graphite flakes, nickel coated graphite flakes, silver coated graphite flakes, gold coated graphite flakes, silver flakes, silver particles) in an amount between about 40 to about 70 wt % of the electrically conductive filler. On the other hand, preferred embodiments of the intermediate layer will have high aspect ratio fillers (e.g., carbon nanofibers, carbon nanotubes, carbon fiber, chopped carbon fiber and nickel coated variants) in an amount between about 10 to about 50 wt %. Preferred embodiments for carbon nanotubes is an amount between about 0.1 to about 5 wt %. Especially preferred embodiment of the intermediate layer will include carbon nanofibers in an amount between 1-10 wt %.

The average particle size of the electrically conductive filler may range between about 10 nm to about 500 μm. In this regard, low aspect ratio fillers (e.g., graphite flakes, nickel coated graphite flakes, silver coated graphite flakes, gold coated graphite flakes, silver flakes, silver particles) may have an average face diameter between about 1 to about 100 μm, preferably between about 1 to about 25 μm, and an average thickness of from about 25 nm to about 5 μm, preferably between about 0.5 to about 2 μm. Carbon nanofibers will preferably be employed having an average diameter of between about 20 to about 200 nm and an average length of between about 30 to 100 μm. Carbon fibers will preferably be employed having an average diameter of between about 4 to about 10 μm and an average length of several micrometers up to several millimeters in length. Thus, carbon fibers may be employed in the intermediate coating layer in average lengths between about 100 to about 450 μm or even between about 3 to about 6 mm.

Specific examples of commercially available conductive fillers include Silflake®450 and Silflake® 135 from Technic Inc, nickel flake HCA-1 from Novamet Specialty Products Corporation, nickel coated graphite flake from Novamet Specialty Products Corporation, Pyrograf® III PR-19-HT and Pyrograf®-III PR-24-XT-HHT nanofibers from Pyrograf® Products Incorporated, Tenax® Milled Carbon Fiber PLS005, Tenax® Chopped Carbon Fiber PLS004 and Tenax® G30-500 Nickel Coated Carbon Fiber from Toho Tenax.

Preferred resin matrix materials include epoxy and urethane based resins, such as bisphenol-A based epoxies (e.g., Epon™ 828) cured with modified polyamide, modified aliphatic amine, amidoamine, cycloaliphatic amine, aromatic amine hardening agents, and polyurethanes. Especially preferred curing agents include Ancamide® 2353 from Air Products, Ancamide® 2432 from Air Products, Versamine® C31 from Cognis, EpiKure®D 3277 from Hexion Specialty Chemicals, and EpiKure® 3072 from Hexion Specialty Chemicals.

The intermediate layer coating compositions may also include any other conventional additive in amounts to achieve the desired effect provided that the friction and dielectric properties as discussed above are not deleteriously affected by their presence. Thus, conventional solvents, additives such as flexibilizers, color pigments, thixotropic agents and other fillers to adjust viscosity, coating performance, potlife, and other performance properties well known to those skilled in the art may be employed as desired.

The intermediate coating formulations are preferably formulated to allow application by any suitable conventional technique for example, spray coating, roll coating, trowel coating, casting and the like.

### III. Primer Layer

The primer layer 18 may optionally be employed so as to enhance radar attenuation of the coating system 10. In this regard, the primer layer will necessarily include a particulate magnetic filler blended with a resin matrix, preferably in amounts between about 40 to about 70 wt. %, preferably 55 to about 65 wt. %, based on the total primer layer formulation weight. The magnetic filler material will have an average particle size of between about 1 to about 20 μm, preferably 3 to about 10 μm.

Exemplary magnetic fillers that may be employed satisfactorily in the primer layer include iron silicide particles, carbonyl iron particles, ferrite particles, iron-nickel particles, cobalt-nickel particles, and the like. Preferred are iron silicide particles. Specific examples of suitable magnetic fillers include Iron Silicide Type III from Steward Advanced Materials, carbonyl iron ER grade powder from BASF and carbonyl iron powder grades S1651 or S5641 from READE Advanced Materials.

Advantageously, the primer layer formulation includes a corrosion inhibitor since the primer layer will typically be applied directly upon the surface of a substrate 12 formed of metal. The corrosion inhibitor will preferably be present in a corrosion inhibiting effective amount between about 1 to about 15 wt. %, preferably between about 5 to about 10 wt. %, based on the total weight of the primer layer. Preferred corrosion inhibitors include zinc phosphate, zinc phosphate-kaolin clay hybrid, amine modified zinc-phosphate-kaolin clay hybrid, cyclohexylamine-zinc phosphase blend, cyclohexylamine-zinc phosphate-kaolin clay hybrid. Specific commercially available corrosion inhibitors include Wayncor® 227 and Waynco® 229 from Wayne Pigment Corp, and Zinc Phosphate J0852 from Rockwood Pigments.

The primer layer coating compositions may also include any other conventional additive in amounts to achieve the desired effect provided that the friction and dielectric properties as discussed above are not deleteriously affected by their presence. Thus, conventional solvents, additives such as flexibilizers, color pigments, thixotropic agents and other fillers to adjust viscosity, coating performance, potlife, and other performance properties well known to those skilled in the art may be employed as desired.

The primer coating formulations are preferably formulated to allow application by any suitable conventional technique for example, spray coating, roll coating and the like.

Each of the topcoat, intermediate and primer layers 12, 14 and 16, respectively, is applied as noted above and allowed sufficient time for the two component resin and hardener to react and cure. Thus, a “cured” material is a hardened layer.

The present invention will be further understood by reference to the following non-limiting Examples.

### Example 1

### Topcoat (Non-Skid) Formula No. T-1

(Example of optimal permittivity (∈′))

The following formulation was made as identified as Topcoat (Non-skid) Formula T-1 as described in Table 1 below:

TABLE 1

| | Wt % |
|---|---|
| Part A - Base | |
| Liquid epoxy resin (e.g. Epon ™ 828) | 28.2% |
| Thickening agent (e.g. Garamite ® 1958 by Southern | 1.4% |
| Clay Products) | |
| Dielectric fillers (e.g. Zeeospheres ™ G200) | 24.6% |
| Abrasion resistant media (e.g. Alodur ® alumina) | 39.8% |
| n-butanol solvent | 6.0% |
| Part B | |
| Modified polyamide resin solution (e.g. Ancamide ® 2353) | 100% |
| Mix Ratio by Weight 5.8:1 Part A:Part B | |

Part A was made by stirring the dielectric fillers and 40 wt % of the epoxy resin using either a pneumatic mixer or through a dual asymmetric, non-invasive mixer such as the FlackTek SpeedMixer™. The solvent was then added in a 50% portion and mixed thoroughly, followed by the abrasion resistant media. The remaining epoxy resin was added and stirred, followed by the remaining solvent. The thickening agent was incorporated and mixing was continued until all components were thoroughly mixed.

The non-skid coating of Formula T-1 was made by stirring together all of Part A and all of Part B in the stated mix ratio just prior to application onto a substrate surface by roll coating.

### Example 2

### Topcoat (Non-Skid) Formula No. T-2

(Example with Other Dielectric Fillers as Well as Color Pigments)

The following formulation was made as identified as Topcoat (Non-skid) Formula T-2 as described in Table 2 below:

TABLE 2

| | Wt % |
|---|---|
| Part A - Base | |
| Liquid epoxy resin (e.g Epon ™ 828) | 24.1% |
| Thickening agent (e.g. Garamite ® 1958) | 2.0% |
| Dielectric fillers (e.g. Zeeospheres ™ G200) | 16.9% |
| Dielectric talc filler (e.g. Nicron ® 403) | 2.8% |
| Dielectric wollasonite filler (e.g. Vancote ® W50ES) | 4.7% |
| Abrasion resistant media (e.g. Alodur ® alumina) | 39.6% |
| Color pigment - Titanium dioxide (white) (e.g. TiPure ® R- | 0.38% |
| 960 by DuPont) | |
| Color pigment (black) (e.g. 10201Eclipse ™ Black by | 0.42% |
| Ferro Pigments) | |
| Color pigment (blue) (e.g. Sunfast ® Blue 15:3/v23 by | 0.02% |
| Sun Chemicals) | |
| Color pigment (red) (e.g. EcoRed 12300 by Heucotech | 0.03% |
| Ltd) | |
| Matting agent (e.g. Syloid ® 222 by Syloid Silica) | 3.3% |
| Solvent (e.g. n-butanol) | 5.7% |
| Part B | |
| Modified polyamide resin solution (e.g. Ancamide ® 2353) | 100% |
| Mix Ratio by Weight 6.8:1 Part A:Part B | |

Part A was made by stirring the color pigments and 60 wt % of the epoxy resin using either a pneumatic mixer or through a dual asymmetric, non-invasive mixer such as the FlackTek SpeedMixer™. The talc and wollastonite minerals were added and thoroughly mixed. The solvent was then added in a 50% portion and mixed thoroughly, followed by the Zeeosphere™ dielectric fillers. The remaining epoxy resin was added and stirred, followed by the remaining solvent. The alumina aggregate was then slowly added and mixed thoroughly. The matting agent was added and incorporated followed by the thickening agent and mixing was continued until all components were thoroughly mixed.

The non-skid coating of Formula T-2 was made by stirring together all of Part A and all of Part B in the stated mix ratio just prior to application to a substrate surface by roll coating.

### Example 3

### Topcoat (Non-Skid) Formula No. T-3

### (Example of Spray Formulation.)

The following formulation was made as identified as Topcoat (Non-skid) Formula T-3 as described in Table 3 below:

TABLE 3

| | Wt % |
|---|---|
| Part A - Base | |
| Liquid epoxy resin (e.g. Epon ™ 828) | 21.5 |
| Defoamer (e.g. Byk ® A535 from Byk-Chemie) | 0.3 |
| Dielectric wollasonite filler (e.g. Vancote ® W50ES) | 3.3 |
| Dielectric talc filler (e.g. Nytal ® 3300) | 1.5 |
| Dielectric filler (e.g. Zeeospheres ™ G200) | 14.2 |
| Abrasion resistant media (e.g. Alodur ® alumina) | 44.5 |
| Thickening agent (e.g. Garamite ® 1958) | 1.6 |
| Solvent (e.g. n-butyl acetate) | 8.7 |
| Solvent (e.g. Aromatic 100 fromExxon Mobile) | 1.8 |
| Solvent (e.g. n-butanol) | 2.6 |
| Part B | |
| Modified polyamide resin solution (e.g. Ancamide ® 2353) | 100% |
| Mix Ratio by Weight 7.7:1 Part A:Part B | |

Part A was made by stirring the defoamer and 60 wt % of the epoxy resin using either a pneumatic mixer or through a dual asymmetric, non-invasive mixer such as the FlackTek SpeedMixer™. The talc and wollastonite minerals were added incrementally and thoroughly mixed. The n-butyl acetate solvent was then added in a 50% portion and mixed thoroughly, followed by incremental addition of the Zeeosphere™ dielectric fillers and the alumina aggregate. The remaining epoxy resin and n-butyl acetate were added and stirred thoroughly. The remaining solvents were added and incorporated followed by the thickening agent and mixing was continued until all components were thoroughly mixed.

The non-skid coating of Formula T-3 was made by stirring together all of Part A and all of Part B in the stated mix ratio just prior to application to a surface by spray coating.

### Example 4

### Intermediate Formula No. I-1

The following formulation was made as identified as Intermediate Formula I-1 as described in Table 4 below:

TABLE 4

| | Wt % |
|---|---|
| Part A - Base | |
| Liquid epoxy resin (e.g. Epon ™ 828) | 39.2 |
| Conductive filler (e.g. Pyrograf ®-III PR-19-HT carbon | 10.9 |
| nanofibers) | |
| Solvent t-butyl acetate | 17.6 |
| Extender pigment (e.g. Calcium metasilicate, Wayne Pigment) | 18.6 |
| Extender pigment (e.g. Talc, Wayne Pigment) | 13.7 |
| Part B - Hardener | |
| Modified polyamide resin solution (e.g. Ancamide ® 2353) | 41.2 |
| Dielectric fillers (e.g. Zeeospheres ™ G200) | 58.8 |
| Mix Ratio by Weight 1.7:1 Part A:Part B | |

Part A was made by stirring the carbon nanofibers and 40 wt % of the epoxy resin using a dual asymmetric, non-invasive mixer such as the FlackTek SpeedMixer™ for a minimum of 5 minutes, 30 seconds at 2000 rpm. An additional 20 wt % of the epoxy resin was added and mixed using the SpeedMixer for an additional 5 minutes, 30 seconds at 2000 rpm. One third of the solvent was added and mixed, followed by incremental addition of the calcium metasilicate and talc, with complete mixing between component additions. The final 40% of the epoxy resin was incorporated and mixed, followed by addition of the remaining solvent and mixing was continued until all components were thoroughly mixed.

Part B was made by stirring the polyamide resin with the dielectric fillers using either a pneumatic mixer or through a dual asymmetric, non-invasive mixer such as the FlackTek Speed Mixer™.

The intermediate coating of Formula I-1 was made by stirring together all of Part A and all of Part B in the stated mix ratio just prior to application.

### Example 5

### Intermediate Formula No. I-2

The following formulation was made as identified as Intermediate Formula I-2 as described in Table 5 below:

TABLE 5

| | Wt % |
|---|---|
| Part A - Base | |
| Liquid epoxy resin (e.g. Epon ™ 828) | 39.0 |
| Dispersion agent (e.g. Novec ™ Fluorosurfactant FC-4432, | 0.5 |
| 3M ™) | |
| Conductive filler (e.g. Pyrograf ®-III PR-19-HT carbon | 10.8 |
| nanofibers) | |
| Solvent t-butyl acetate | 17.5 |
| Extender pigment (e.g. Calcium metasilicate, Wayne Pigment) | 18.5 |
| Extender pigment (e.g. Talc, Wayne Pigment) | 13.6 |
| Part B - Hardener | |
| Modified polyamide resin solution (e.g. Ancamide ® 2353) | 41.2 |
| Dielectric fillers (e.g. Zeeospheres ™ G200) | 58.8 |
| Mix Ratio by Weight 1.7:1 Part A:Part B | |

Part A was made by stirring the dispersion aid and 40 wt % of the epoxy resin using a dual asymmetric, non-invasive mixer such as the FlackTek SpeedMixer T until thoroughly incorporated. The carbon nanofibers were then added and mixed for a minimum of 5 minutes, 30 seconds at 2000 rpm. An additional 20 wt % of the epoxy resin was added and mixed using the SpeedMixer for an additional 5 minutes, 30 seconds at 2000 rpm. One third of the solvent was added and mixed, followed by incremental addition of the calcium metasilicate and talc, with complete mixing between component addition. The final 40% of the epoxy resin was incorporated and mixed, followed by addition of the remaining solvent and mixing was continued until all components were thoroughly mixed.

Part B was made by stirring the polyamide resin with the dielectric fillers using either a pneumatic mixer or through a dual asymmetric, non-invasive mixer such as the FlackTek Inc SpeedMixer™.

The intermediate coating of Formula I-2 was by stirring together all of Part A and all of Part B in the stated mix ratio just prior to application.

### Example 6

### Intermediate Formula No. I-3

The following formulation was made as identified as Intermediate Formula I-3 as described in Table 6 below:

TABLE 6

| | Wt % |
|---|---|
| Part A - Base | |
| Liquid epoxy resin (e.g. Epon ™ 828) | 44.6 |
| Dispersion agent (e.g. Novec ™ Fluorosurfactant FC-4432, | 0.5 |
| 3M ™) | |
| Conductive filler (e.g. Pyrogra ®-III PR-24-XT-HHT carbon | 5.5 |
| nanofibers) | |
| Solvent t-butyl acetate | 17.5 |
| Extender pigment (e.g. Calcium metasilicate from Wayne | 18.4 |
| Pigment) | |
| Extender pigment (e.g. Talc from Wayne Pigment) | 13.6 |
| Part B - Hardener | |
| Modified polyamide resin solution (e.g. Ancamide ® 2353) | 44.7 |
| Dielectric fillers (e.g. Zeeospheres ™ G200) | 55.3 |
| Mix Ratio by Weight 1.7:1 Part A:Part B | |

Part A was made by stirring the dispersion agent and 20 wt % of the epoxy resin using a dual asymmetric, non-invasive mixer such as the FlackTek SpeedMixer™ until thoroughly incorporated. The carbon nanofibers were then added and mixed for a minimum of 5 minutes, 30 seconds at 2000 rpm. An additional 20 wt % of the epoxy resin was added and mixed using the SpeedMixer for an additional 5 minutes, 30 seconds at 2000 rpm. One third of the solvent was added and mixed, followed by incremental addition of the calcium metasilicate and talc, with complete mixing between component addition. The final 60% of the epoxy resin was incorporated and mixed, followed by addition of the remaining solvent and mixing was continued until all components were thoroughly mixed.

Part B was made by stirring the polyamide resin with the dielectric fillers using either a pneumatic mixer or through a dual asymmetric, non-invasive mixer such as the FlackTek SpeedMixer™.

The intermediate coating of Formula I-3 was made by stirring together all of Part A and all of Part B in the stated mix ratio just prior to application.

### Example 7

### Primer Formula No. P-1

The following formulation was made as identified as Primer Formula P-1 as described in Table 7 below:

TABLE 7

| | Wt % |
|---|---|
| Part A - Base | |
| Liquid epoxy resin (e.g. Epon ™ 828) | 20.0% |
| Magnetic filler (e.g. Iron Silicide Type III) | 69.7% |
| Corrosion Inhibitor (e.g. Wayncor ® 229) | 4.5% |
| Dispersion Aid (e.g. Antiterra ®-U 80 from Byk) | 1.1% |
| Solvent t-butyl acetate | 3.4% |
| Part B - Hardener | |
| Modified polyamide resin solution (e.g. Ancamide ® 2353) | 100% |
| Mix Ratio by Weight 8:1 Part A:Part B | |

Part A was made by stirring the dispersion aid, magnetic filler and 40 wt % of the epoxy resin using either a pneumatic mixer or through a dual asymmetric, non-invasive mixer such as the FlackTek SpeedMixer™. The t-butyl acetate solvent was then added and mixed thoroughly, followed by incremental addition of the corrosion inhibitor. The remaining epoxy was added and stirred until all components were thoroughly mixed.

The primer of formula P-1 was made by stirring together all of Part A and all of Part B in the stated mix ratio just prior to application.

### Example 8

### Coefficient of Friction (COF) Testing

Test samples were prepared from topcoat Formula T-1 above and tested according to Section 4.5.1 of MIL-PRF-24667B(SH). COF results performed on samples after 500 cycles of wear are provided below in Table 8. Minimum COF requirements for Type I non-skid coatings according to MIL-PRF-24667B(SH) after wear are 0.90 under dry conditions, 0.85 under wet conditions, and 0.75 under oily conditions. As shown, the nonskid coating formulation of Formula T-1 provided excellent non-skid, high friction properties which met the requirements of MIL-PRF-24667B(SH).

TABLE 8

| | Dry | | Wet | | Oily | |
|---|---|---|---|---|---|---|
| | Panel 1 | Panel 2 | Panel 1 | Panel 2 | Panel 1 | Panel 2 |
| Comparative: | 1.17 ± 0.08 | — | 1.08 ± 0.33 | — | 0.92 ± 0.04 | — |
| Commercial | | | | | | |
| Nonskid | | | | | | |
| Coating MS- | | | | | | |
| 400G | | | | | | |
| Invention: | 1.27 ± 0.08 | 1.26 ± 0.18 | 1.25 ± 0.10 | 1.15 ± 0.08 | 0.81 ± 0.05 | 0.77 ± 0.12 |
| Formula T-1 | | | | | | |

### Example 9

### Permittivity Loss Tangent (tan δ) of Topcoat

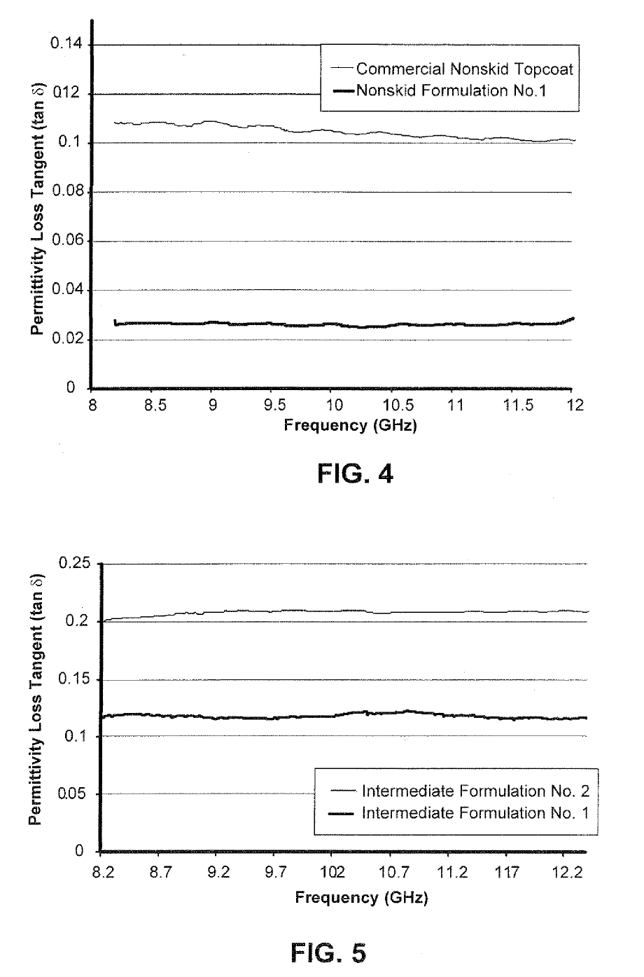

Cured topcoat samples of Formula T-1 were measured in an X-band waveguide from 8-12 GHz using an Agilent N5230A Vector Network Analyzer. The insertion loss and phase data S-parameters (S₁₁, S₁₂, S₂₁, and S₂₂) were recorded. These properties were used as inputs into a program that executes a least squares fit to compute the complex permittivity and permeability using a Nicolson-Ross model. (See, Brousseau et al, IEEE Transactions on Dielectrics and Electrical Insulation, Vol. 11, No. 5, October 2004.) The permittivity loss tangent (tan δ) measured for a cured nonskid topcoat prepared according to Topcoat Formula T-1 is presented FIG. 4. For comparison, the loss tangent (tan δ) of a commercially available nonskid topcoat (MS 400-G from American Safety Technologies) is also presented in FIG. 4. As shown, the presence of low loss dielectric fillers in Formula T-1 of the present invention results in a lower loss non-skid topcoat as compared to the commercially available nonskid topcoat.

### Example 10

### Permittivity Loss Tangent (tan δ) of Intermediate Formulations

Cured intermediate layer samples of Intermediate Formulas I-1 and I-2 were measured in an X-band waveguide from 8-12 GHz using an Agilent N5230A Vector Network Analyzer. The insertion loss and phase data S-parameters (S₁₁, S₁₂, S₂₁, and S₂₂) were recorded. These properties were used as inputs into a program that executes a least squares fit to compute the complex permittivity and permeability using a Nicolson-Ross model. The permittivity loss tangent (tan δ) for Intermediate formulations prepared according to Intermediate Formulas I-1 and I-2 are presented in FIG. 5. The two formulations differ by the use of a dispersion agent which allows for an increased loss to be realized in the coating without an increase in the amount of nanofibers.

### Example 11

### Impact Resistance

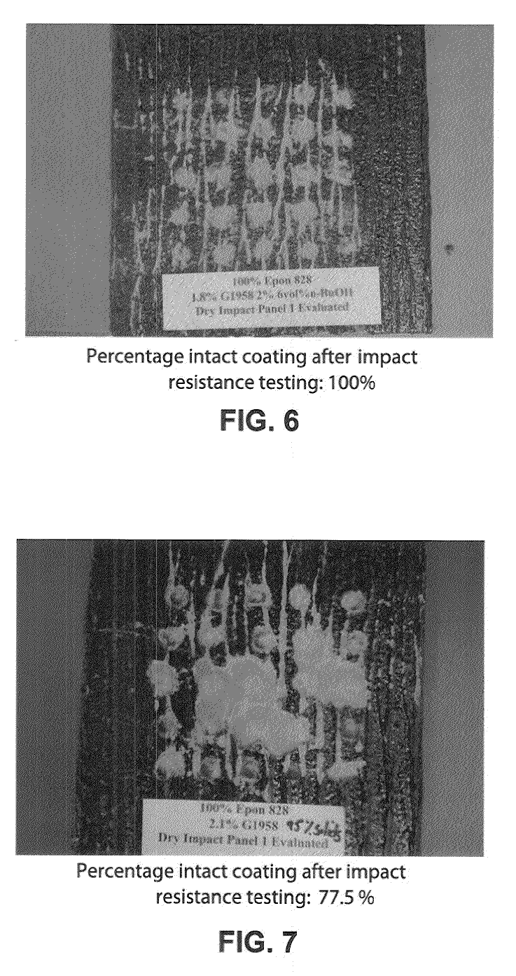

The resistance of the Topcoat Formula T-1 to impact was tested and rated according to the methodology detailed in MIL-PRF-24667B(SH) which minimally requires 95% of the coating to remain intact for a Type I non-skid coating. Visual evidence of the post-impact results are depicted in FIGS. 6 and 7. The formulation of FIG. 6 was as described above in reference to Formula T-1 in Table 1. The formulation of FIG. 7 was a modified version of Formula T-1 of Table 1 and differed only in the incorporation of n-butyl acetate instead of n-butanol. The results demonstrate that, while friction, dielectric loss, and application properties are suitable for each formulation, the use of n-butyl acetate would not meet impact resistance requirements of MIL-PRF-24667B(SH).

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A high friction, radar attenuating coating formulation comprising:
a resin matrix;
a particulate friction additive dispersed in the resin matrix in an amount sufficient to achieve a minimum coefficient of friction according to MIL-PRF-24667B(SH); and
a particulate dielectric filler dispersed in the resin matrix in an amount sufficient to achieve a permitivitty (∈′) of less than about 10 and a loss tangent (tan δ) of less than about 0.05.

2. A coating formulation as in claim 1, wherein the dielectric filler is at least one selected from the group consisting of calcium magnesium silicate, magnesium silicate hydroxide, magnesium aluminum silicate, potassium aluminum silicate, alkali alumino silicate, wollastonite, talc and muscovite

3. A coating formulation as in claim 2, wherein the dielectric filler contains less than 2 vol. % of impurities.

4. A coating formulation as in claim 1, wherein the dielectric filler is present in an amount to achieve a permitivitty of between about 1.5 to about 10.

5. A coating formulation as in claim 1, wherein the dielectric filler is present in an amount of between about 14 to about 45 wt. %, based on the total weight of the coating formulation.

6. A coating formulation as in claim 1, wherein the dielectric filler has an average particle size of between about 0.1 to about 200 μm.

7. A coating formulation as in claim 1, wherein the friction additive is at least one selected from the group consisting of aluminum ceramics and polymeric particulates.

8. A coating formulation as in claim 7, wherein the friction additive is at least one selected from the group consisting of aluminum oxide, alumina-zirconia oxide, alumina-spinel materials, polyethylene grit and polypropylene grit.

9. A coating formulation as in claim 1, wherein the friction additive is present in an amount between about 30 to about 70 wt. %, based on the total weight of the coating formulation.

10. A coating formulation as in claim 1, wherein the friction additive is present in an amount sufficient to achieve a coefficient of friction before wear under both dry and wet conditions according to MIL-PRF-24667B(SH) of at least about 1.00.

11. A coating formulation as in claim 1, wherein the friction additive has an average particle size of between about 30 grit to about 80 grit.

12. A cured coating material which comprises a hardened residue of the coating formulation as in any one of claims 1-11.

13. A substrate coated with a coating system which comprises a cured coating formulation as in claim 1.

14. A substrate as in claim 13, wherein the coating formulation is present as a topcoat layer applied directly onto a surface of the substrate.

15. A substrate as in claim 13, wherein the coating formulation is present as a topcoat layer on the substrate, and wherein the coating system further comprises an intermediate layer interposed between the topcoat layer and a surface of the substrate.

16. A substrate as in claim 15, wherein the coating system further comprises a primer layer coated directly onto the surface of a substrate between the intermediate layer and the substrate.

17. A substrate as in claim 15, wherein the intermediate layer comprises an electrically conductive filler dispersed in a resin matrix that may be the same as or different from the resin matrix of the topcoat layer.

18. A substrate as in claim 17, wherein the electrically conductive filler is at least one selected from carbon nanofibers, carbon nanotubes, carbon fibers, graphite flakes, aluminum powders, and particulate metals.

19. A substrate as in claim 17, wherein the electrically conductive filler includes at least one metal coated filler selected from the group consisting of metal-coated carbon nanofibers, metal-coated carbon nanotubes, metal-coated carbon fibers, metal-coated graphite flakes and metal-coated aluminum powders.

20. A substrate as in claim 17, wherein the electrically conductive filler is present in an amount sufficient to achieve a conductivity of between about 25 to about 2000 μΩ-cm.

21. A substrate as in claim 20, wherein the electrically conductive filler is present in an amount between about 0.1 to about 70 wt. %, based on the total weight of the intermediate layer.

22. A substrate as in claim 16, wherein the primer layer comprises a particulate magnetic filler dispersed in a resin matrix which may be the same as of different from the resin matrix of the coating formulation forming the topcoat layer.

23. A substrate as in claim 22, wherein the magnetic filler is present in an amount between about 40 to about 70 wt. %, based on the total weight of the primer layer.

24. A substrate as in claim 22, wherein the magnetic filler has an average particle size of between about 1 to about 20 μm.

25. A method of coating a substrate to impart anti-slip and radar attenuating properties thereto which comprises applying onto a substrate surface a coating layer comprised of a flowable coating formulation as in claim 1, and thereafter allowing the coating formulation to harden on the substrate surface.

26. A method as in claim 25, wherein the coating formulation is applied so as to form a series of substantially parallel ridges having a predetermined directional orientation.

27. A method as in claim 26, wherein the coating formulation is applied to a block area on the substrate surface comprised of plural areal regions, wherein the directional orientation of the substantially parallel ridges of one areal region are angularly biased with respect to the directional orientation of the substantially parallel ridges of an adjacent areal region.

28. A method as in claim 27, wherein the angular bias between the parallel ridges is greater than 0° to less than 180°.

29. A method as in claim 27, wherein between 2 to 20 areal regions are provided, and wherein the angular bias between the parallel ridges of adjacent ones of the areal regions is between about 30° to about 90°.

30. A coated substrate comprising a metal substrate and a coating system coated on a surface of the substrate, wherein the coating system comprises:
a topcoat layer;
a primer layer coated onto the substrate surface; and
an intermediate layer interposed between the primer and topcoat layers.

31. A coated substrate as in claim 30, wherein the topcoat layer is comprised of a cured coating formulation comprised of:
a first resin matrix;
a particulate friction additive dispersed in the resin matrix in an amount sufficient to achieve a minimum coefficient of friction according to MIL-PRF-24667B(SH); and
a particulate dielectric filler dispersed in the resin matrix in an amount sufficient to achieve a permitivitty (∈′) of less than about 10 and a loss tangent (tan δ) of less than about 0.05.

32. A coated substrate as in claim 31, wherein the primer layer comprises a particulate magnetic filler dispersed in a second resin matrix which may be the same as of different from the first resin matrix.

33. A coated substrate according to claim 32, wherein the intermediate layer comprises an electrically conductive filler dispersed in a third resin matrix that may be the same as or different from the first and/or second resin matrices.

34. A coated substrate according to claim 30, wherein the topcoat layer comprises a series of substantially parallel ridges having a predetermined directional orientation.

35. A coated substrate comprising:
a topcoat layer on a block area of a substrate surface, the block area having plural areal regions, wherein
the topcoat layer includes a series of substantially parallel ridges having a predetermined directional orientation, and wherein
the directional orientation of the substantially parallel ridges of one areal region are angularly biased with respect to the directional orientation of the substantially parallel ridges of an adjacent areal region.

36. A coated substrate as in claim 35, wherein the angular bias between the parallel ridges is greater than 0° to less than 180°.

37. A coated substrate as in claim 35, wherein between 2 to 20 areal regions are provided, and wherein the angular bias between the parallel ridges of adjacent ones of the areal regions is between about 30° to about 90°.

38. A coated substrate as in claim 35, wherein the topcoat layer is comprised of a cured coating formulation comprised of:
a resin matrix,
a particulate friction additive dispersed in the resin matrix in an amount sufficient to achieve a minimum coefficient of friction according to MIL-PRF-24667B(SH); and
a particulate dielectric filler dispersed in the resin matrix in an amount sufficient to achieve a permitivitty (∈′) of less than about 10 and a loss tangent (tan δ) of less than about 0.05.

39. A coated substrate as in claim 38, further comprising a primer layer coated onto the substrate surface, and an intermediate layer interposed between the primer and topcoat layers.
